(19) United States
(12) Patent Application Publication
(10) Pub. No.: US 2003/0163827 A1
(43) Pub. Date: Aug. 28, 2003

(54) High risk personnel real time monitoring support apparatus

(76) Inventor: William J. Purpura, Anaheim, CA (US)

Correspondence Address: HARNESS, DICKEY & PIERCE, P.L.C., P.O. BOX 828, BLOOMFIELD HILLS, MI, 48303, US

(21) Appl. No.: 10/087,583

(22) Filed: Feb. 28, 2002

(51) Int. Cl. H04N 7/173; H04N 7/18

(52) U.S. Cl. 725/105; 348/143; 342/357.12; 342/357.06

(57) ABSTRACT

A monitoring apparatus for monitoring a position and an activity of an individual wearing the monitoring apparatus as well as providing real time access to a wireless LAN. The monitoring apparatus includes a set of hardware, a controller, a power source and at least one user-wearable article. The set of hardware includes a positioning receiver, which determines the position of the individual and generates a position signal in response thereto, and one or more video cameras, which monitor an associated activity of the individual and generate an associated activity video signal in response thereto. The controller, which is coupled to the set of hardware, receives the signal transmitted therefrom and forwards these signals to a remote monitoring station in real time via a wireless interface. The power supply provides electrical power to the set of hardware and the controller. The articles house the set of hardware, the controller and the power supply and is wearable by the individual.

### FIELD OF THE INVENTION

The present invention relates generally to a self-contained integrated monitoring support apparatus, and more particularly to a real-time monitoring apparatus that observes and/or records an individual's movements while working in a predefined area while providing them access to broadband LAN's for real time support while performing assigned tasks.

### BACKGROUND OF THE INVENTION

Known in the art are detection apparatuses for detecting the position of a human eye. These devices can be employed to determine the wakefulness or drowsiness of a person while operating equipment, such as a motorized vehicle. Also known in the art are remote medical diagnostic systems, which are employed to provide real-time medical consultation via phone lines. These systems are employed, for example, on aircraft to transmit and receive a combination of voice data and digital information data to and from remotely located support personnel to aid in the diagnosis of a patient in the aircraft. Such systems typically use narrow-band airphone technology and as such are extremely limited by the rate at which digital data can be transmitted and received. Generally, digital data is transmitted at a rate of 9.6 kB, even when a separate airphone line is employed for transmitting digital data. Accordingly, the user of this equipment is typically able to send and receive limited real-time data, compressed snap shot telemetry data, or very limited video data from a hand held camera.

While such systems may be adequate for their intended purpose, they typically lack the speed and sophistication that is necessary for use in the field of security. In this regard, there remains a need for a self-contained integrated monitoring apparatus to detect and record an individual's movement by utilizing real-time imaging technology. Further, this lack of capacity has hindered such systems from allowing real time access to support data by the system user.

### SUMMARY OF THE INVENTION

The forgoing drawbacks are overcome by the high risk personnel real time monitoring apparatus in accordance with the preferred embodiments of the present invention. The apparatus overcomes aforementioned disadvantages as well as other disadvantages by monitoring in real time the movements and activities of personnel in high risk positions.

A self-contained monitoring apparatus is utilized to monitor movement of an individual operating in a predetermined area. A central control system that is configured to be worn by a monitored individual provides the power required to control the components of the apparatus, as well as a device for communicating with an external command center. A head-borne telecommunication system and a pair of arm-borne modules detect the movement of the monitored individual and this information is relayed to the central control center via a communication cable. The central control system communicates the activities of the monitored individual in real time to an external command center. The present invention is ideally suited for the secure monitoring of personnel operating in high-risk or non-viewable areas, such as in the loading and/or maintenance of aircraft, where security and rapid response may be necessary. Additionally, the invention allows real time two-way support to the user while operating under such conditions.

Further areas of applicability of the present invention will become apparent from the detailed description provided hereinafter. It should be understood that the detailed description and specific examples, while indicating the preferred embodiment of the invention, are intended for purposes of illustration only and are not intended to limited the scope of the invention.

### BRIEF DESCRIPTION OF THE DRAWINGS

The present invention will become more fully understood from the detailed description and the accompanying drawings, wherein:

FIG. 1 is perspective view of an individual wearing the real time monitoring apparatus constructed in accordance with the teachings of a preferred embodiment of the present invention;

FIG. 2 is a perspective view a portion of the real time monitoring apparatus of FIG. 1 illustrating the head worn telecommunication system in greater detail;

FIG. 3 is a perspective view a portion of the real time monitoring apparatus of FIG. 1 illustrating the first one of the arm modules in greater detail;

FIG. 4 is a perspective view a portion of the real time monitoring apparatus of FIG. 1 illustrating the second one of the arm modules in greater detail;

FIG. 5 is a perspective view a portion of the real time monitoring apparatus of FIG. 1 illustrating the central control system in greater detail; and

FIG. 6 is a schematic illustration of the real time monitoring apparatus of FIG. 1.

### DETAILED DESCRIPTION OF THE PREFERRED EMBODIMENTS

The following description of the preferred embodiment(s) is merely exemplary in nature and is in no way intended to limit the invention, its application, or uses.

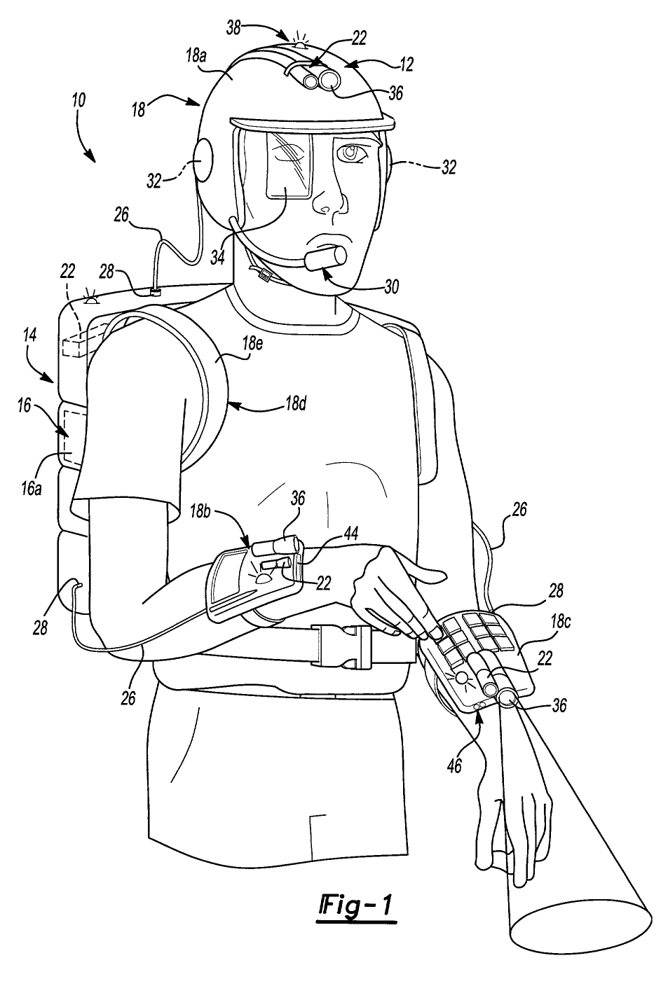

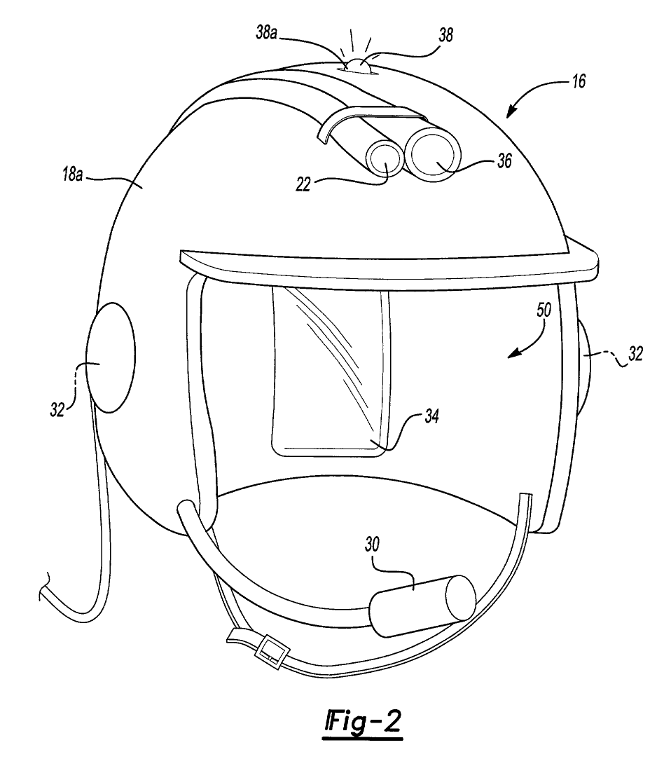

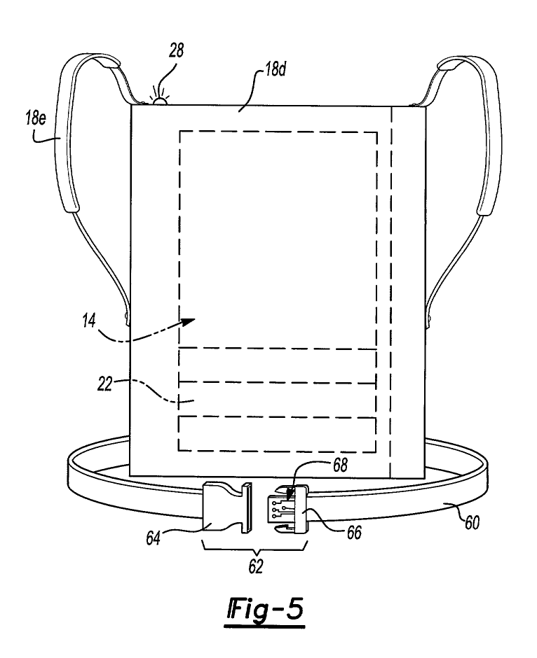

With reference to FIGS. 1 through 6 of the drawings, a real time monitoring apparatus 10 constructed in accordance with the teachings of the present invention is shown in operative association with an individual that is to be monitored. The apparatus 10 is shown to include a set of hardware 12, a controller 14, a power supply 16 and one or more articles 18 that house the hardware 12, the controller 14 and the power supply 16 and which are wearable by the individual. The power supply 16 is preferably a rechargeable battery pack 16a that is removably coupled to the controller 14 and which provides electrical power to the controller 14 and the set of hardware 12. In the particular example provided, the four articles 18a, 18b, 18c and 18d are provided.

Article 18a is fabricated from an impact resistant material and shaped in the form of a helmet that is worn on the head of the individual. Articles 18b and 18c are modules that are configured to be releasably coupled to the arm or wrist of the individual. Article 18d is a backpack having a pair of shoulder straps 18e that are configured to permit the article 18d to be carried on the back of the individual.

The hardware 12 is illustrated to include a positioning receiver 20 and one or more video cameras 22. The positioning receiver 20 is attached to the article 18d and is operable for determining the position of the individual and generating a position signal in response thereto. In the example provided, the positioning receiver 20 is a global positioning satellite (GPS) receiver of the type that is well known in the art.

Each of the video cameras 22 is operable for monitoring the activity of the individual and generating an associated activity video signal in response thereto. In the particular embodiment illustrated, the hardware 12 includes three video cameras 22, with a first one of the video cameras 22 being coupled to the article 18a and oriented to capture video images that are representative of what the individual is viewing, and the remaining video cameras 22 being coupled to articles 18b and 18c and oriented to capture video images that detail what the individual is doing with their hands. The video cameras 22 are preferably color charge coupled device (CCD) video cameras that are flush mounted to the article 18 to which they are attached.

The hardware 12 is coupled to the controller 14 and power supply 16 via a plurality of cables 26 that preferably utilize quick disconnects 28 to permit the hardware 12 and controller 14 to be readily coupled and uncoupled. The cables 26 transmit electrical power to each hardware component, and where appropriate, transmit data to and/or from the hardware components. It is presently preferred that the cables 26 be constructed in a manner so as to carry all conductors that are necessary for linking the controller 14 and power supply 16 to a given article 18. Accordingly, each cable 26 preferably includes one or more sets of wires for distributing electrical power to the hardware components that are coupled to a given article 18, as well as one or more conductors for transmitting data to and/or from the hardware components that are coupled to the article 18. The conductors for transmitting data may be conventional wire conductors for conducting an electrical signal, or may be fiber optic cables for transmitting optical signals. The consolidation of all conductors into a single cable 26 with quick disconnects 28 permits the individual to select from a plurality of differently sized cables 26 to tailor the length of the cable 26 to their size and build, thereby ensuring that the cables 26 are not too long, which might increase the risk that the cable 26 would become entangled with another object, or too short, which would tend to limit the individual's range of motion.

The hardware 12 may optionally include other items, such as a microphone 30, headphones or speakers 32, a heads-up display device 34, task lights 36, alarm devices 38 and data entry and transmission devices, such as a keypad 40, a scratch pad 42, a bar code scanner 44 and an infrared transmitter/receiver 46. The microphone 30 and speakers 32 are coupled to the article 18a and cooperate with the controller 14 to form a telecommunication system 50 that permits the individual to communicate with other individuals in a wireless manner. As the speakers 32 are embedded into the article 18a, and as background noise damping is employed to filter the input received from the microphone 30, the telecommunication system 50 may be employed in noisy environments, as well as to control one or more functions of the apparatus 10 via voice-activated commands. The heads-up display device 34 is coupled to the article 18a and generally aligned to one of the individual's eyes to permit the display of dense data with a screen that is relatively small in size and weight.

The task lights 36 are preferably selectively controllable via the controller 14 to illuminate when either insufficient light is available for the video cameras 22 or when the individual desires additional lighting. Accordingly, it is preferred that each of the task lights 36 is mounted to an associated one of the articles (e.g., articles 18a, 18b and 18c) proximate an associated video camera 22.

The alarm devices 38 may include devices for generating signals, such as radio frequency, infrared, auditory or visual signals, to alert the individual or others in the vicinity of the individual to the occurrence of a predetermined situation, fault, error or malfunction. In the example provided, the alarm devices 38 include warning strobes 38a that are coupled to each of the articles 18. Each warning strobe 38a is activated by the controller 14 when the controller 14 determines that an associated one of the articles 18 is not properly secured to the individual. This determination may be made, for example, through a sensor 68 that is coupled to the clip mechanism 62 that is employed to secure the article 18 to the individual. For example, the waist strap 60 of the article 18d includes a clip mechanism 62 having a female latch portion 64, a male latch portion 66 and a sensor 68 that is coupled to the male latch portion 66 and which generates a latch signal which is used to illuminate an associated warning strobe 38a when the apparatus 10 is activated and the male latch portion 66 is not engaged to the female latch portion 64. One or more of the warning strobes 38a may also be selectively illuminated by the controller 14 upon the occurrence of a software and/or hardware error or fault and/or the individual's unapproved access into a predetermined area.

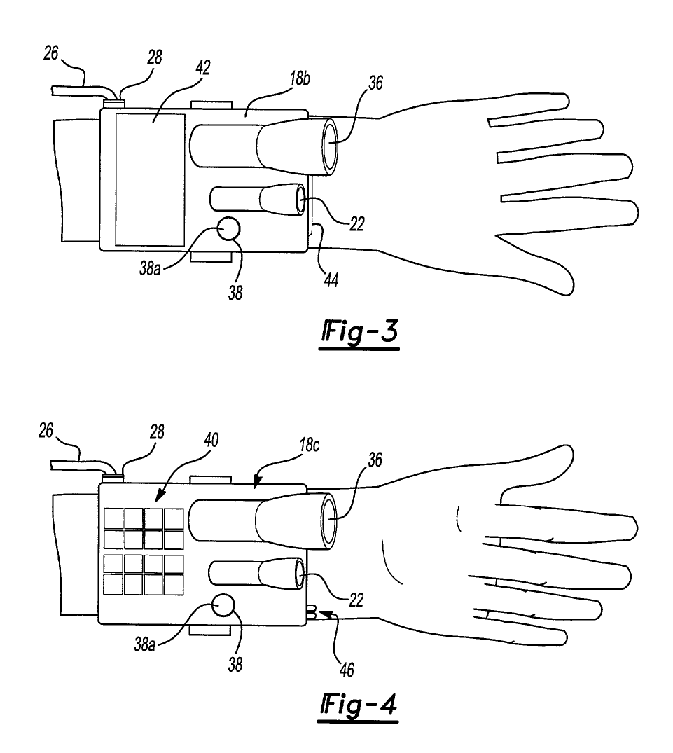

With reference to FIGS. 3 and 4, the data entry and transmission devices are illustrated to include, for example, a keypad 40, a scratch pad 42, a bar code scanner 44 and an infrared transmitter/receiver 46. The keypad 40 is preferably highly simplified and permits the individual to manually enter data to the controller 14. The scratch pad 42 permits the individual to input data to the controller 14 through a series of predetermined menus and/or through handwriting recognition software. The bar code scanner 44 is conventional and permits the individual to input bar coded information to the controller 14. The infrared transmitter/receiver 46 is likewise conventional and permits the individual to transmit information between the controller 14 and another device in a wireless manner. Examples of devices with which the infrared transmitter/receiver 46 may communicate include electronic locks to gain or restrict access to a given area, and computer systems to upload information from or download information to the controller 14. Such information may include, for example, task lists, detailed maintenance instructions, inventory listings, material safety data sheets, and first aid instructions.

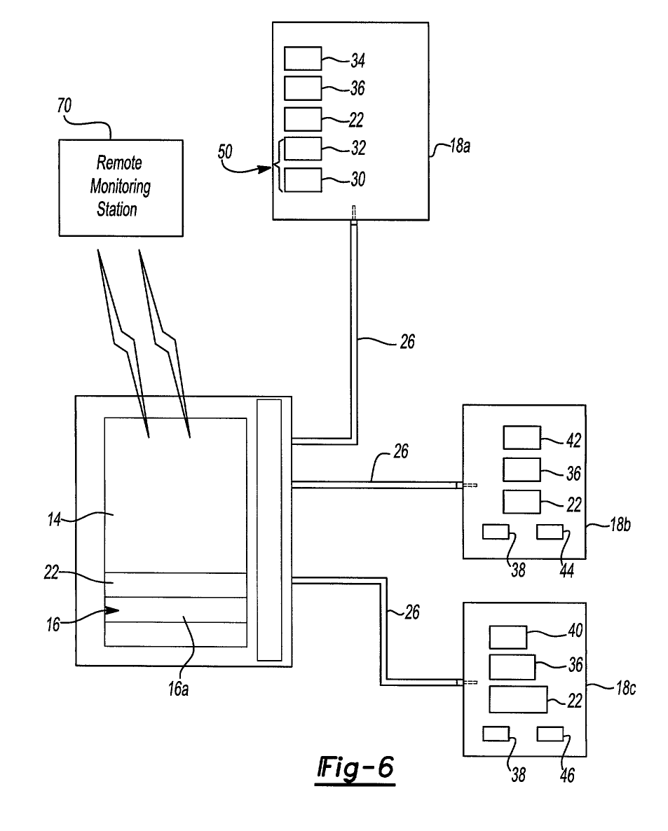

With reference to FIG. 6, the hardware 12 is coupled to the controller 14 to permit the controller 14 to receive data from and/or transmit data to the hardware components. The controller 14 is operable for interpreting data received from the hardware 12 according to a predetermined methodology, and for transmitting data to and receiving data from a remote monitoring station 70 via a wireless interface, such as an IEEE 802.11 wireless interface. Connection to the remote monitoring station 70 may be initiated manually by the individual, or automatically by the controller 14 upon the individual's entry into a predetermined area.

The controller 14 is further operable for transmitting voice data to and receiving voice data from the remote monitoring station 70 by telephony over internet protocol (IP) or cell phone technology. The controller 14 is also operable for conducting diagnostic testing on itself and the hardware 12 as well as for employing the position signal to determine the present location of the individual.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A monitoring apparatus for monitoring a position and at least one activity of an individual wearing the monitoring apparatus as well as providing real time access to a wireless LAN, the monitoring apparatus comprising:
a set of hardware including a positioning receiver and at least one video camera, the positioning receiver being operable for determining the position of the individual and generating a position signal in response thereto, the at least one video camera being operable for monitoring an activity of the individual and generating an associated activity video signal in response thereto;
a controller coupled to the positioning receiver and the at least one video camera and receiving the position signal and each activity video signal, the controller being configured to forward the position signal and each activity video signal to a remote monitoring station in real time via a wireless interface;
a power supply for powering the positioning receiver, the at least one video camera and the controller; and
at least one article for housing the positioning receiver, the at least one video camera, the controller and the power supply, the at least one article being wearable by the individual.

2. The monitoring apparatus of claim 1, wherein the positioning receiver is a GPS receiver.

3. The monitoring apparatus of claim 1, wherein the at least one article includes an article that is configured to be worn on a head of the individual.

4. The monitoring apparatus of claim 1, wherein the at least one article includes an article that is configured to be worn on a limb of the individual.

5. The monitoring apparatus of claim 4, wherein the article is configured to be worn on a wrist of the individual.

6. The monitoring apparatus of claim 1, further comprising a heads up display for displaying a set of data transmitted thereto by the controller.

7. The monitoring apparatus of claim 1, wherein the at least one video camera includes a first video camera that is configured to be coupled to the head of the individual.

8. The monitoring apparatus of claim 7, wherein the at least one video camera further includes a second video camera coupled to an arm of the individual.

9. The monitoring apparatus of claim 8, further comprising a plurality of lights, each of the lights being coupled to the at least one article proximate each of the first and second video cameras, each of the lights being selectively controllable to provide a source of light.

10. The monitoring apparatus of claim 1, wherein the power supply is a battery pack.

11. The monitoring apparatus of claim 10, wherein the battery pack is removable and rechargeable.

12. The monitoring apparatus of claim 1, wherein at least one alarm device is coupled to the at least one article, the at least one alarm device being configured to generate an alarm signal if the individual has entered an unauthorized area.

13. The monitoring apparatus of claim 12, wherein the alarm device is a lamp and the alarm signal is the illumination of the lamp.

14. The monitoring apparatus of claim 1, further comprising at least one cable for releasably interconnecting the set of hardware to the controller.

15. The monitoring apparatus of claim 1, further comprising a microphone for sensing sound in an area proximate the individual and generating a sound signal in response thereto, the sound signal being received by the controller.

16. The monitoring apparatus of claim 1, wherein at least one of the articles includes a data entry device that is configured to input data to the controller that is manually entered by the individual.

17. The monitoring apparatus of claim 16, wherein the data entry device is selected from a group consisting of keypads and scratch pads.
